(19) United States
(12) Patent Application Publication
(10) Pub. No.: US 2022/0202240 A1
(43) Pub. Date: Jun. 30, 2022

(54) COOKING APPARATUS

(71) Applicants: DANIEL MARK AMBRIZ, PAMPA, TX (US); FEDERICO LOUIS AMBRIZ, Pampa, TX (US)

(72) Inventors: DANIEL MARK AMBRIZ, PAMPA, TX (US); FEDERICO LOUIS AMBRIZ, Pampa, TX (US)

(21) Appl. No.: 17/565,216

(22) Filed: Dec. 29, 2021

Related U.S. Application Data
(60) Provisional application No. 63/131,715, filed on Dec. 29, 2020.

(51) Int. Cl. A47J 37/07; A47J 37/10; A47J 33/00; A47J 45/06

(52) U.S. Cl. CPC A47J 37/0786; A47J 45/061; A47J 33/00; A47J 37/10

(57) ABSTRACT

cooking apparatus comprising a pan portion having a food receiving surface and an oppositely facing outer surface and a grate portion having a food receiving surface and an oppositely facing outer surface. The pan portion and the grate portion together have a closed configuration and an open configuration. In the closed configuration, the pan portion and the grate portion together define a food-receiving interior volume. In the open configuration, there is an access opening to permit access to the food-receiving interior volume to thereby permit the deposit of food onto and removal of food from the food-receiving interior volume. In use, the cooking apparatus has a food frying orientation whereat the pan portion is below the grate portion to thereby permit frying of food, and a food grilling orientation whereat the grate portion is below the pan portion to thereby permit grilling of food.

### FIELD OF THE INVENTION

The present invention relates to apparatuses for cooking on a grill, barbeque, over an open flame and the like, which apparatuses permit grilling, frying, searing, and other specialty cooking for various types of foods.

### BACKGROUND OF THE INVENTION

In this present day, many individuals take pride in seasoning and cooking their own food in this overly saturated market of fast-food chains. Unfortunately, making a delicious home-cooked meal takes time, energy, and uses various cooking materials to get the job done right. Therefore, many people turn to fast-food restaurants to get their food in a quick and easy manner. The downside about this fast-food convenience is the buyer sacrifices high quality food for convenience of time. When cooking outside on a grill, a person is limited to only grilling their food and is unable to use various cooking techniques on the food. This limitation causes a person to waste time to find another area to cook the food.

Many individuals have attempted to solve this issue by bringing pots and pans outside with them, thereby allowing them to cook the food in multiple different ways at once without going back inside. However, this solution is cumbersome and clutters up the grill space with multiple different cooking items, thereby making the cooking a difficult process.

Further, cooking full sized pieces of meat or similar is often done by placing the meat on a grill that is over a gas-fired heat source, a burning charcoal, an open fire, or the like. However, the cooking of meals that consist of smaller pieces of meat, chopped vegetables, and so on, such as a stir fry, it is not possible on a grill.

One known relevant prior art apparatus is described in U.S. Pat. No. 9,615,69262 issued Apr. 11, 2017, to Hoffmann et al, and entitled Grill And/Or Frying Plate For The Use On Cooking Hobs. This grill and/or frying plate is for use on an induction cooking hob, and includes at least one grill section and at least one section different from the grill section, in particular a frame section or a warming section. When the grill and/or frying plate is mounted to the cooking hob, the at least one grill section is at least partially arranged directly above at least one heating element of the cooking hob and that the at least one section different from the grill section is at least partially arranged in a position where no heating element is arranged below. A recess and/or a securing recess and/or a fixation groove are arranged in a region that delimits the grill section from the section different from the grill section, in such a way that the heat transfer from the grill section to the section different from the grill section is reduced.

Another known relevant prior art apparatus is described in United States Published Patent Application No. US20120266760A1, published Oct. 25, 2012, to Bryce et al, and entitled Outdoor Grill With Integrated Griddle. This grill includes a firebox having a burning chamber and an open upper end, a first horizontal cooking surface disposed over the burning chamber, a domed lid resting atop the burning chamber and enclosing the first horizontal cooking surface and having an opening through a top side thereof, and a panel resting atop the opening in either a first position in which the panel is a lid portion to close the opening, or a second position in which the panel serves as a second horizontal cooking surface disposed above the first horizontal cooking surface and exposed to the burning chamber through the opening.

It is an object of the present invention to provide an apparatus for cooking food, wherein the apparatus has a pan portion and a grate portion.

It is an object of the present invention to provide an apparatus for cooking food, wherein the apparatus has a pan portion and a grate portion, and wherein the apparatus has a food frying orientation whereat the pan portion is below the grate portion to thereby permit frying of food, and a food grilling orientation whereat the grate portion is below the pan portion to thereby permit grilling of food.

It is an object of the present invention to provide an apparatus for cooking meals that consist of smaller pieces of meat, chopped vegetables, and so on, such as a stir fry, it is not possible on a grill or barbecue, over an open fire, or the like.

Other objects, advantages, features, and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### SUMMARY OF THE INVENTION

In accordance with one aspect of the present invention there is disclosed a novel cooking apparatus comprising a pan portion having a food receiving surface and an oppositely facing outer surface and a grate portion having a food receiving surface and an oppositely facing outer surface. The pan portion and the grate portion together have a closed configuration and an open configuration. In the closed configuration, the pan portion and the grate portion together define a food-receiving interior volume at least partially bounded by the food receiving surfaces of the pan portion and the grate portion, and food within the food-receiving interior volume can contact the food receiving surface of the pan portion and the grate portion. In the open configuration, there is an access opening to permit access to the food-receiving interior volume thereby to permit the deposit of food onto and removal of food from the food-receiving interior volume. In use, the cooking apparatus has a food frying orientation whereat the pan portion is below the grate portion to thereby permit frying of food, and a food grilling orientation whereat the grate portion is below the pan portion to thereby permit grilling of food.

In accordance with one aspect of the present invention there is disclosed a novel method of cooking food comprising the steps of: placing food in a food-receiving interior volume of a cooking apparatus; and performing one or both of: placing the cooking apparatus fry-side up and grill-side down against a source of heat to grill the food in the food-receiving interior volume thereof; and placing the cooking apparatus grill-side up and fry-side down against a source of heat to fry the food in the food-receiving interior volume thereof.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the apparatus according to the present invention, as to its structure, organization, use and method of operation, together with further objectives and advantages thereof, will be better understood from the following drawings in which a presently known embodiment of the invention will now be illustrated by way of example. It is expressly understood, however, that the drawings are for the purpose of illustration and description only and are not intended as a definition of the limits of the invention. In the accompanying drawings:

FIG. 1A is a perspective view of a first illustrated embodiment cooking apparatus according to the present invention, in a closed configuration and in a food frying orientation on a grill;

FIG. 1B is a perspective view of the first illustrated embodiment cooking apparatus of FIG. 1A, in a closed configuration and in a food grilling orientation on a grill;

FIG. 2A is a side elevational view of the first illustrated embodiment cooking apparatus and grill of FIG. 1A, with the first illustrated embodiment cooking apparatus in a closed configuration and shown in cross section taken along section lie 2A-2A in FIG. 1A, and in a food frying orientation on the grill;

FIG. 2B is side elevational view of the first illustrated embodiment cooking apparatus and grill of FIG. 1B, with the first illustrated embodiment cooking apparatus in a closed configuration and shown in cross section taken along section lie 2B-2B in FIG. 1A, and in a food grilling orientation on the grill;

FIG. 3A is a perspective view of the first illustrated embodiment cooking apparatus of FIG. 1A, in a closed configuration;

FIG. 3B is a perspective view of the first illustrated embodiment cooking apparatus of FIG. 1A, in an open configuration;

FIG. 4 is an exploded perspective view of the first illustrated embodiment cooking apparatus of FIG. 1A;

FIG. 5 is a top plan view of the first illustrated embodiment cooking apparatus of FIG. 1A;

FIG. 6 is a side elevational view of the first illustrated embodiment cooking apparatus of FIG. 1A;

FIG. 7 is a front end view of the first illustrated embodiment cooking apparatus of FIG. 1A;

FIG. 8 is a back end view of the first illustrated embodiment cooking apparatus of FIG. 1A;

FIG. 9 is a front elevational view of a second illustrated embodiment cooking apparatus according to the present invention, in an open configuration; and,

FIG. 10 is a side elevational view of a third illustrated embodiment cooking apparatus according to the present invention, in a closed configuration.

### LIST OF REFERENCE NUMERALS AND COMPONENTS

100 cooking apparatus

102 food

104 barbeque/grill

120 pan portion

121a front

121b back

121c left side

121d right side

122 food receiving surface

124 oppositely facing outer surface

126 top edge

128 flat base

130 peripheral wall portion

131a front wall

131b back wall

131c left side wall

131c first grill-receiving wall

131d second grill-receiving wall

131d right side wall

132 food-receiving interior volume

133 access opening

134 bottom edge

138a first grill-receiving groove therein

138b second grill-receiving groove therein

140 grate latch

142 main handle screw

144 side handle clamps

146 main handle

147 main handle hanging hole

149a left side handle

149b right side handle

150 grate portion

151a front

151b back

151c left side

151d right side

152 food receiving surface

154 oppositely facing outer surface

156 metal bars

158 grate bar connectors

160 rail system

162 sideways U-shaped groove system

164 oppositely facing outer surface

164a left side rail

164b right side rail

164c front rail

166 metal bars

166a inwardly facing left side groove

166b inwardly facing right side groove

166c inwardly facing front groove

168 grate bar connectors

200 cooking apparatus

220 pan portion

260 grate portion

270 hinge

300 cooking apparatus

310 side wall grate

312 plurality of apertures

320 pan portion

“A” arrow

### DETAILED DESCRIPTION OF THE ILLUSTRATED EMBODIMENTS

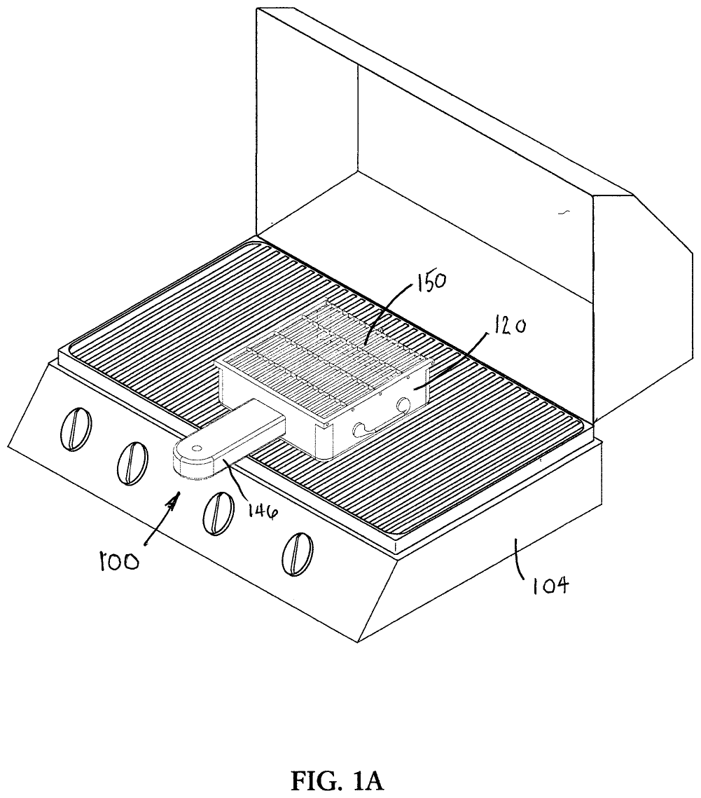

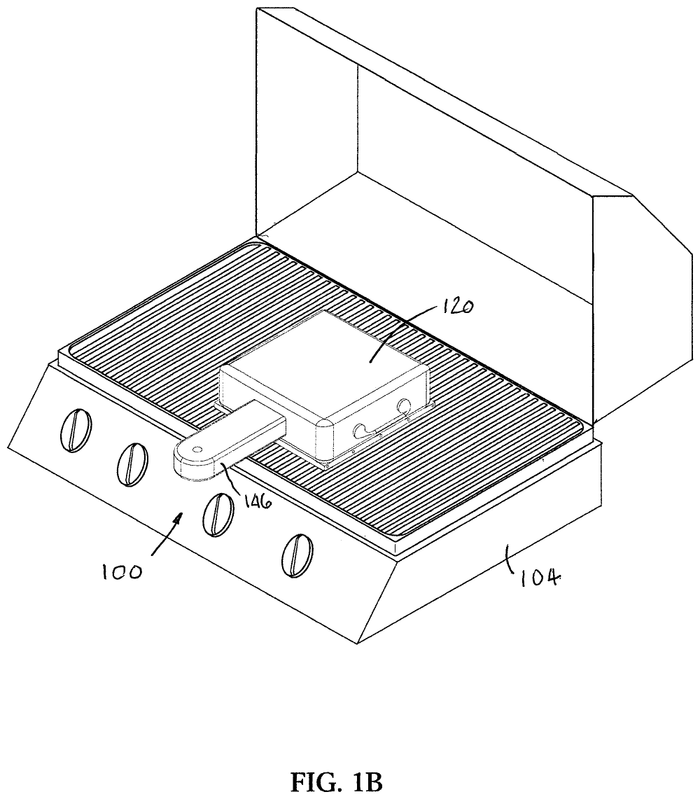

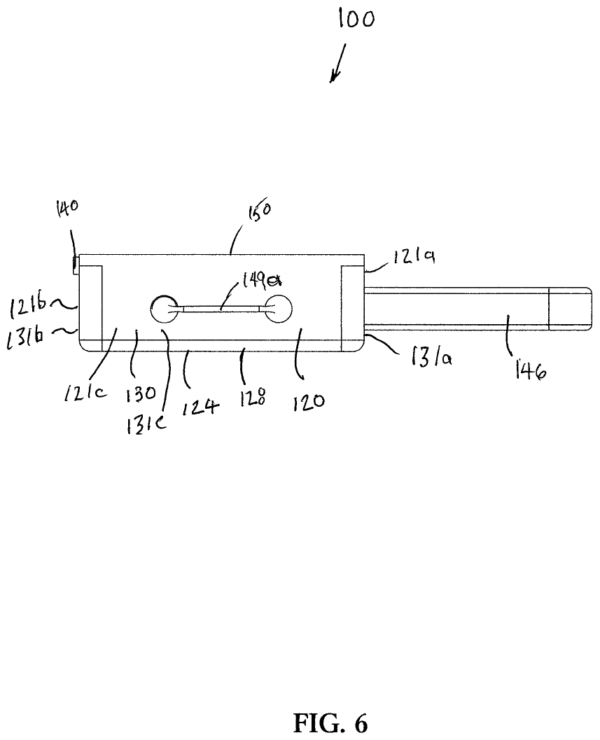

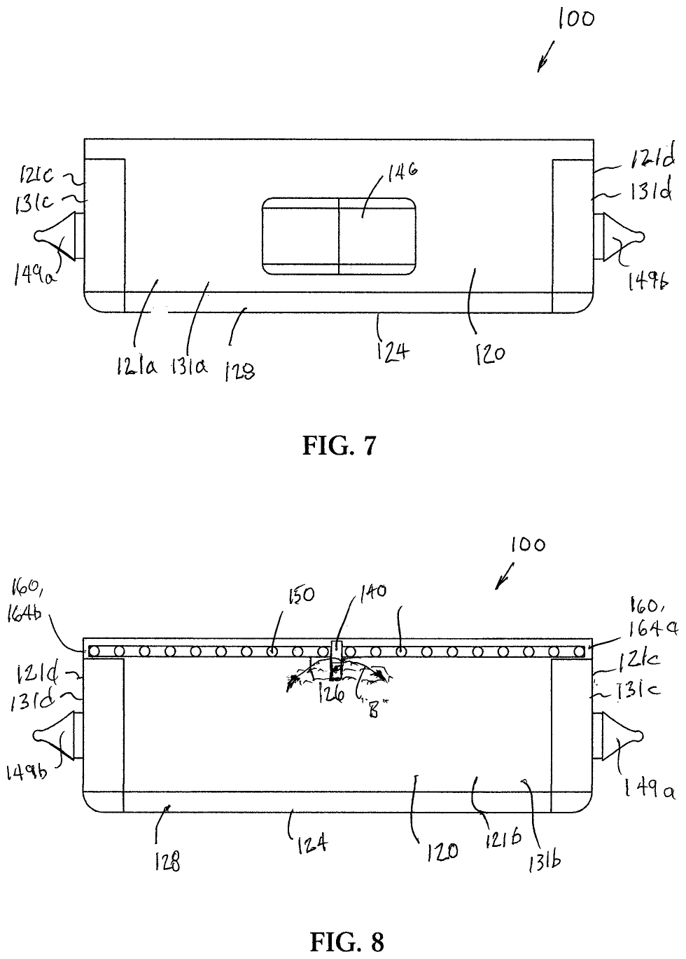

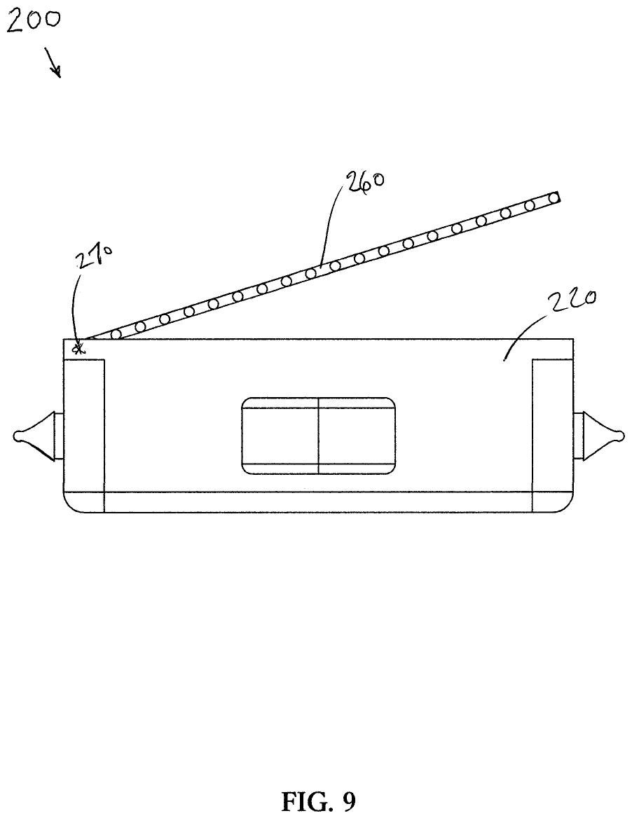

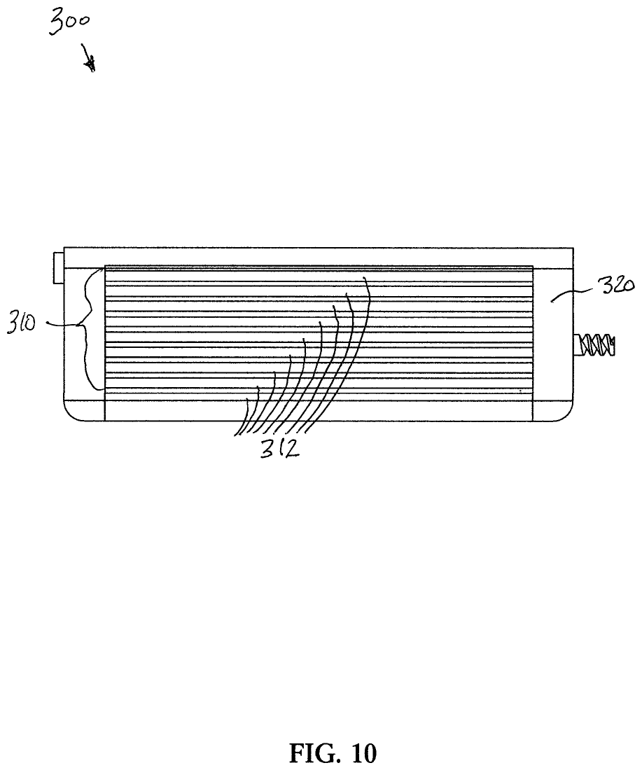

Reference will now be made to FIGS. 1A through 10 to describe the various illustrated embodiments of the cooking apparatus according to the present invention. More specifically, reference will now be made to FIGS. 1A through 8 to describe the first illustrated embodiment of the cooking apparatus 100 according to the present invention, reference will now be made to FIG. 9 to describe the second illustrated embodiment of the cooking apparatus 200 according to the present invention, and reference will now be made to FIG. 10 to describe the third illustrated embodiment of the cooking apparatus 300 according to the present invention.

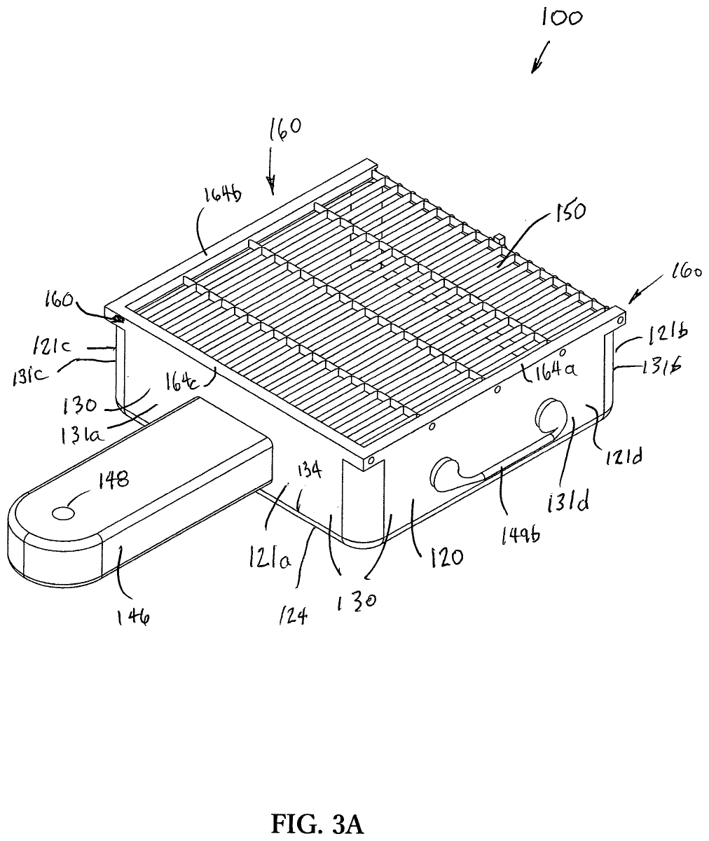

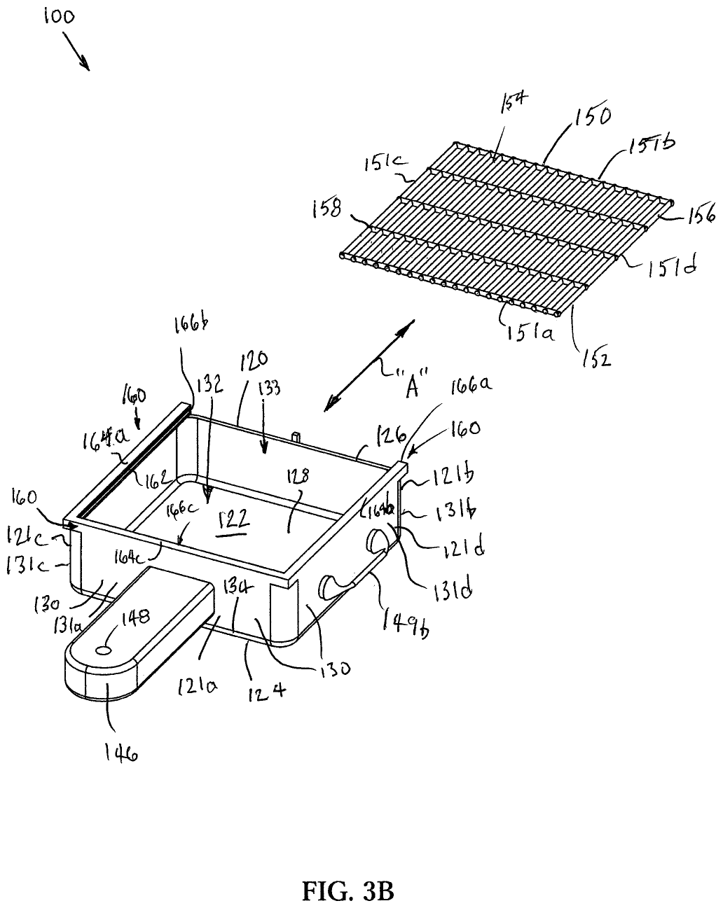

The first illustrated embodiment of the cooking apparatus 100 according to the present invention will now be described with reference to FIGS. 1A through 8. In brief, the first illustrated embodiment of the cooking apparatus 100 according to the present invention is for cooking food 102 within the cooking apparatus 100 over a source of heat, such as a barbeque/grill 104, and comprises a pan portion 120 and a grate portion 150. The pan portion 120 and the grate portion 150 together have a closed configuration, as can be seen in FIGS. 1A, 1B, 2A, 2B, 3A, 5, 6, 7 and 8, an open configuration, as can be seen in FIG. 3B, and a separated configuration whereat the grate portion 150 and the pan portion 120 are separated each from the other.

More specifically, in the first illustrated embodiment cooking apparatus, the pan portion 120 has a food receiving surface 122 and an oppositely facing outer surface 124, a top edge 126, and a substantially flat base 128.

The pan portion 120 also has a front 121a, a back 121b, a left side 121c and a right side 121d. The pan portion 120 includes a peripheral wall portion 130 surrounding a food-receiving interior volume 132. The peripheral wall portion 130 extends from a bottom edge 134 at the pan portion 120 to the top edge 126 of the pan portion 120, and comprises a front wall 131a, a back wall 131b, a left side wall 131c and a right side wall 131d. In the first illustrated embodiment, the left side wall 131c comprises a first grill-receiving wall 131c and the right side wall 131d comprises a second grill-receiving wall 131d. The first grill-receiving wall 131c is substantially flat and the second grill-receiving wall 131d is substantially flat. The first grill-receiving wall 131c and the second grill-receiving wall 131d are disposed opposite each other with respect to the food-receiving interior volume 132.

The pan portion 120 can be made from a material that allows heat to be conducted easily from the source of heat, such as a barbeque/grill 104, to the food 102 within the cooking apparatus 100 and that will not change its shape when subjected to high cooking temperatures. Some of the edges of the pan portion 120 may be rounded and curved to allow for easy cleaning of the pan portion 120 when the cooking apparatus is not in use.

The cooking apparatus further comprises a main handle 146, a left side handle 149a and a right side handle 149b, each securely connected to at least one of the grate portion 150 and the pan portion 120 for permitting the cooking apparatus to be lifted and manipulated by a user. In the first illustrated embodiment cooking apparatus, the main handle 146 is securely connected to the front wall 131a of the pan portion 120, the left side handle 149a is securely connected to the left side wall 131c of the pan portion 120, and right side handle 149b is securely connected to the right side wall 131d of the pan portion 120.

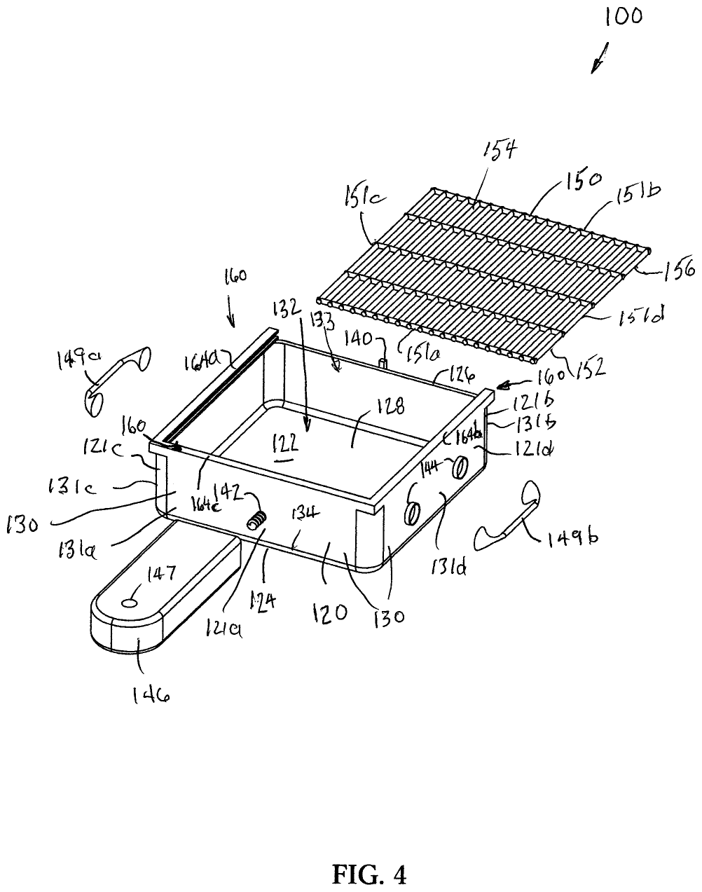

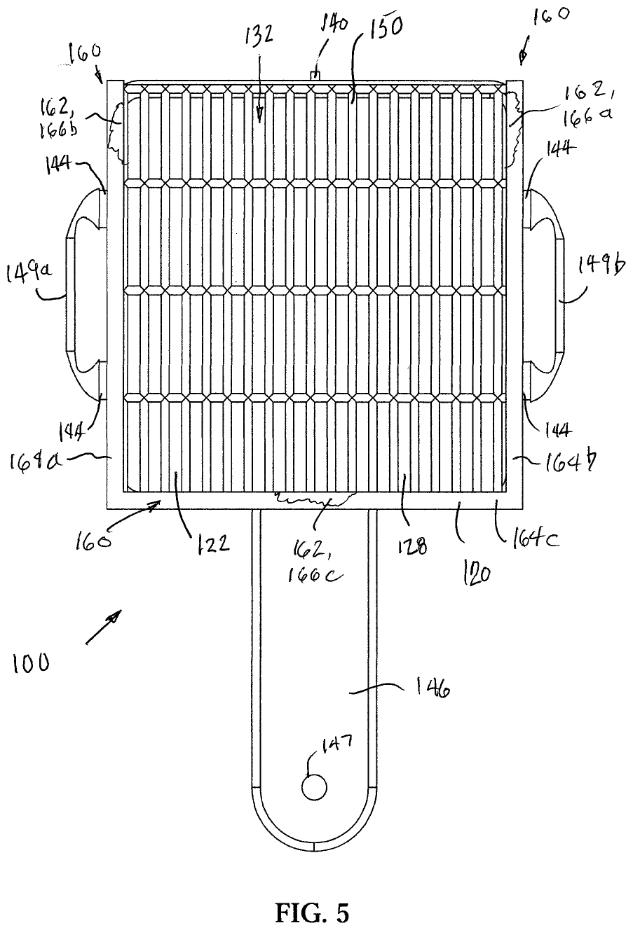

As can be best seen in FIG. 4, the exploded view, the pan portion 120 also comprises a grate latch 140, a main handle screw 142 and side handle clamps 144 (also see FIG. 5). The grate latch 140 helps keep the grate in place during manipulation of the cooking apparatus 100 via use of the handles. The main handle screw 142 receives the main handle 146 in threaded engagement in a co-operating threaded aperture (not specifically shown). The main handle 146 is made of a material with a low thermal conductivity thereby allowing the user to safely grasp the handle while the temperature of the cooking apparatus remains hot. As indicated by double-ended arrow “B” in FIG. 8, the grate latch 140 is movable between a grate locking position as shown in solid lining, and a grate-passing position as shown in dashed lining.

The attachment of the main handle 146 is not limited to a screw attachment system and can use various attachment methods such as a clamp system, latch system, and the like, to hold the main handle 146 or the side handles 149a,149b onto the pan portion 120.

The main handle 146 also has a main handle hanging hole 147 disposed at the outer end of the main handle 146 to allow for hanging up of the cooking apparatus when not in use.

As also can be best seen in FIG. 4, there are the side handle clamps 144 on the left side wall 131c and the right side wall 131d of the pan portion 120. The side handle clamps 144 allow for multiple attachments such as the left side handle 149a and the right side handle 149b, and receive the left side handle 149a and the right side handle 149b in secure engagement thereon. The side handles are made of a material with a low thermal conductivity thereby allowing the user to safely grasp the handles while the temperature of the box remains hot.

In the first illustrated embodiment, there is a rail system 160 on the pan portion 120. Preferably, but not necessarily, the rail system 160 is positioned adjacent the top of the pan portion 120. The rail system 160 has sideways U-shaped groove system 162 that receives the grate portion 150 in sliding relation therein.

More specifically, the pan portion 120 includes a left side rail 164a, a right side rail 164b, each interconnected by a front rail 164c. The left side rail 164a has an inwardly facing left side groove 166a, the right side rail 164b has an inwardly facing right side groove 166b, and the front rail 164c has an inwardly facing front groove 166c.

The rail system 160 may be made from any suitable metal material, and may be secured to the pan portion 120 by any suitable means, such as welding. The rail system 160 is designed with a size allowing for a sung fit for the grate portion 150 to engage the first grill-receiving groove 138a and the second grill-receiving groove 138b in sliding relation, to thereby cover the access opening 133.

Similarly to the pan portion 120, the grate portion 150 has a front 151a, a back 151b, a left side 151c and a right side 151d. As illustrated, the grate portion 150 has a food receiving surface 152 and an oppositely facing outer surface 154. The grate portion 150 is a square shape with a size that covers the access opening 133 of the pan portion 120. The grate comprises a plurality, specifically twenty, of metal bars 156 evenly spaced one from the next in parallel relation and a plurality, specifically five, grate bar connectors 158 evenly spaced one from the next in parallel relation. The plurality of metal bars 156 run the length of the grate portion 150 and the grate bar connectors 158 run the width of the grate portion 150. The grate bar connectors 158 are oriented transversely to the metal bars 156 and crossing each other to form a strong flat structure. The placement of the metal bars 156 and the grate bar connectors 158 allows for food to be placed on top of the grate portion 150 without the food falling through the gaps. The first grill-receiving groove 138a and the second grill-receiving groove 138b are each disposed adjacent the top edge 126 of the pan portion 120, and each faces the other. The grate portion 150 engages the first grill-receiving groove 138a and the second grill-receiving groove 138b in sliding relation therein so as to be removable and replaceable, or in other words to go between the closed configuration to the open configuration.

In the closed configuration, the pan portion 120 and the grate portion 150 together define the food-receiving interior volume 132 at least partially bounded by the food receiving surfaces 122 of the pan portion 120 and the food receiving surface 152 of the grate portion 150, and food within the food-receiving interior volume 132 can contact the food receiving surface 122 of the pan portion 120 and the food receiving surface 162 of the grate portion 150. Further, the grate portion 150 is disposed at the access opening 133 of the pan portion 120.

As can be best seen in FIG. 3B, in the open configuration, there is an access opening 133 to permit access to the food-receiving interior volume 132 thereby to permit the deposit of food onto and removal of food from the food-receiving interior volume 132. The access opening 133 is disposed at the top edge 126 of the pan portion 120.

The first illustrated embodiment cooking apparatus further comprises a separated configuration whereat the grate portion 150 and the pan portion 120 are separated each from the other, as best seen in FIG. 3B. As indicated by double-ended arrow “A”, the grate portion 150 slides out of the first grill-receiving groove 138a and the second grill-receiving groove 138b so as to be separated from the pan portion 120.

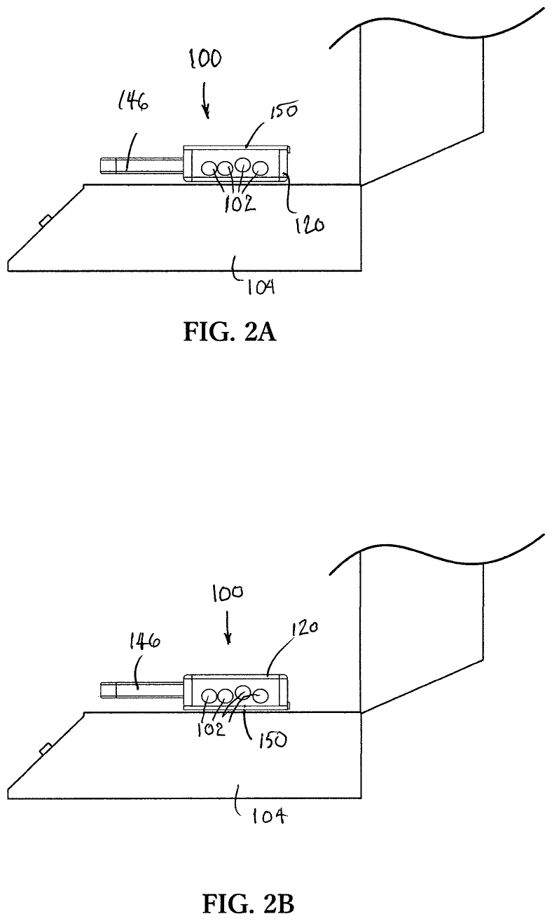

In use, the cooking apparatus 100 has a food frying orientation and a food grilling orientation. In the food frying orientation, as shown in FIGS. 1A and 2A, the pan portion 120 is below the grate portion 150 to thereby permit frying of food on the substantially flat base 128, specifically on the food receiving surface 122, of the pan portion 120. In the food grilling orientation, as shown in FIGS. 1B and 2B, the grate portion 150 is below the pan portion 120 to thereby permit grilling of food on the grate portion 150, specifically on the food receiving surface 152 thereof.

It should also be noted that food can also be cooked on the grate portion 150, specifically on the oppositely facing outer surface 154 of the grate portion 150, when the cooking apparatus 100 is in its food frying orientation.

In the second illustrated embodiment of the cooking apparatus 200, as shown in FIG. 9, the pan portion 220 and the grate portion 260 are attached to each other by a hinge 270 to thereby allow the grate to pivot upwardly and downwardly between the closed configuration and the open configuration.

In the third illustrated embodiment of the cooking apparatus 300, as shown in FIG. 10, the cooking apparatus 300 comprises side wall grate 310 and a plurality of apertures 312. The side wall grate can be positioned on either side of the pan portion 320 and can be made of a metal material that allows for compact grilling of food within the substantially hollow interior of the cooking apparatus 300, with just a simple ninety (90) degree rotation of the cooking apparatus 300.

In another alternative embodiment of the cooking apparatus, it is contemplated that the plurality of apertures comprises four (4) apertures positioned at each lower corner of the pan portion. The apertures create a cylindrical indent with one closed and one open end. Four cylindrical rods can be placed into the four of apertures. This embodiment is designed to be used over a firepit, in a camping situation.

Other variations of the above principles will be apparent to those who are knowledgeable in the field of the invention, and such variations are considered to be within the scope of the present invention. Further, other modifications and alterations may be used in the design and manufacture of the combined cooling, heat and power system according to the present invention, without departing from the spirit and scope of the accompanying claims.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”, “for example”) provided herein, is intended merely to better illuminate embodiments of the invention and does not pose a limitation on the scope of the invention unless otherwise claimed. No language in the specification should be construed as indicating any non-claimed element as essential to the practice of the invention.

Illustrated embodiments of this invention are described herein. Variations of those illustrated embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A cooking apparatus comprising:
a pan portion having a food receiving surface and an oppositely facing outer surface; and,
a grate portion having a food receiving surface and an oppositely facing outer surface;
wherein said pan portion and said grate portion together have a closed configuration and an open configuration;
wherein, in said closed configuration, said pan portion and said grate portion together define a food-receiving interior volume at least partially bounded by said food receiving surfaces of said pan portion and said grate portion, and food within said food-receiving interior volume can contact said food receiving surface of said pan portion and said grate portion;
wherein, in said open configuration, there is an access opening to permit access to said food-receiving interior volume thereby to permit the deposit of food onto and removal of food from said food-receiving interior volume; and,
wherein, in use, said cooking apparatus has a food frying orientation whereat said pan portion is below said grate portion to thereby permit frying of food, and a food grilling orientation whereat said grate portion is below said pan portion to thereby permit grilling of food.

2. A cooking apparatus according to claim 1, wherein said pan portion has a top edge.

3. A cooking apparatus according to claim 2, wherein said access opening is disposed at said top edge of said pan portion.

4. A cooking apparatus according to claim 1, wherein said pan portion includes a peripheral wall portion surrounding said food-receiving interior volume.

5. A cooking apparatus according to claim 4, wherein said peripheral wall portion extends from a bottom edge at said pan portion to a top edge.

6. A cooking apparatus according to claim 5, wherein, in said closed configuration, said grate portion is disposed at said access opening of said pan portion.

7. A cooking apparatus according to claim 1, further comprising a separated configuration whereat said grate portion and said pan portion are separated each from the other.

8. A cooking apparatus according to claim 1, further comprising a handle securely connected to at least one of said grate portion and said pan portion for permitting said cooking apparatus to be lifted and manipulated by a user.

9. A cooking apparatus according to claim 1, wherein said pan portion has a substantially flat base.

10. A cooking apparatus according to claim 1, wherein said peripheral wall portion has a first grill-receiving wall with a first grill-receiving groove therein and a second grill-receiving wall with a second grill-receiving groove therein.

11. A cooking apparatus according to claim 10, wherein said first grill-receiving wall and said second grill-receiving wall are disposed opposite each other with respect to said food-receiving interior volume.

12. A cooking apparatus according to claim 11, wherein said first grill-receiving groove and said second grill-receiving groove each face the other.

13. A cooking apparatus according to claim 12, wherein said pan portion has a top edge.

14. A cooking apparatus according to claim 13, wherein said first grill-receiving groove and said second grill-receiving groove are each disposed adjacent said top edge of said pan portion.

15. A cooking apparatus according to claim 11, wherein said grate portion engages said first grill-receiving groove and said second grill-receiving groove in sliding relation.

16. A cooking apparatus according to claim 12, wherein said first grill-receiving wall and said second grill-receiving wall are substantially flat.

17. A cooking apparatus according to claim 12, further comprising a separated configuration whereat said grate portion and said pan portion are separated each from the other, and said grate portion slides out of said first grill-receiving groove and said second grill-receiving groove so as to be separated from said pan portion.

18. A method of cooking food comprising the steps of:
placing food in a food-receiving interior volume of a cooking apparatus; and,
performing one or both of:
placing said cooking apparatus fry-side up and grill-side down against a source of heat to grill said food in said food-receiving interior volume thereof; and,
placing said cooking apparatus grill-side up and fry-side down against a source of heat to fry said food in said food-receiving interior volume thereof.
